(19) United States
(12) Patent Application Publication
(10) Pub. No.: US 2019/0098127 A1
(43) Pub. Date: Mar. 28, 2019

(54) DRIVER DEVICE LOCKING

(71) Applicant: Hewlett-Packard Development Company, L.P., Houston, TX (US)

(72) Inventors: Monit Gupta, San Diego, CA (US); Christopher C Kruger, San Diego, CA (US)

(21) Appl. No.: 16/097,150

(22) PCT Filed: Jul. 14, 2016
(86) PCT No.: PCT/US2016/042257

§ 371 Date: Oct. 26, 2018

(51) Int. Cl. H04M 1/725; G06K 9/00

(52) U.S. Cl. CPC H04M 1/72577; G06K 9/00617

(57) ABSTRACT

Examples associated with driver device locking are described. One example includes obtaining a user profile associated with a driver of a vehicle. The user profile is obtained by a mobile device and contains information associated with the driver. Iris information of the user of the mobile device is compared to the iris information associated with the driver. Motion of the vehicle is monitored. Access to a feature of the mobile device is locked when the iris information of the user matches the iris information associated with the drive and the vehicle is in motion.

### BACKGROUND

Automobiles and mobile devices are two technologies that are ubiquitous in modern society. Automobiles are a primary means of transportation for a large portion of the population, and cellular phones and tablets allow users to remain connected to each other and global networks from nearly any point on the globe.

### BRIEF DESCRIPTION OF THE DRAWINGS

The present application may be more fully appreciated in connection with the following detailed description taken in conjunction with the accompanying drawings.

FIG. 1 illustrates an example mobile device associated with driver device locking.

FIG. 2 illustrates a flowchart of example operations associated with driver device locking.

FIG. 3 illustrates another flowchart of example operations associated with driver device locking.

FIG. 4 illustrates another example mobile device associated with driver device locking.

FIG. 5 illustrates another example mobile device associated with driver device locking.

FIG. 6 illustrates an example vehicle associated with driver device locking.

FIG. 7 illustrates an example computing device in which example systems, and methods, and equivalents, may operate.

### DETAILED DESCRIPTION

Systems, methods, and equivalents associated with driver device locking are described. When a person is operating a vehicle, distractions can lead to accidents involving property damage and injury. One modern distraction comes from mobile devices being operated while driving. While some applications may be useful while operating a vehicle (e.g., using a mapping application to obtain directions and/or traffic information), other mobile features may hinder a driver's ability to focus on driving. In fact, many locations have begun banning the use of certain mobile device functionality including texting and making or receiving calls while driving to deter drivers from operating the phone and the vehicle simultaneously.

Despite this, some users may still seek to use mobile devices while driving. Consequently, upon entering a vehicle, mobile devices may use iris detection technology to determine when a driver of the vehicle is also attempting to use the mobile device. When the iris of the user of the device and the iris of the driver of the vehicle match, the mobile device may deactivate certain device functionalities such as texting, calling, distracting application, and so forth. If the iris of the driver does not match the iris of the user of the mobile device, such as when the driver hands the mobile device to a passenger, the mobile device may reactivate these functionalities. In some examples, the vehicle may assist the mobile device in determining iris information associated with the driver. In these examples, the vehicle may obtain in iris scan of the user, and transmit the iris scan to the mobile device. When this iris scan matches a scan of the iris of the user, the mobile device may restrict functionalities.

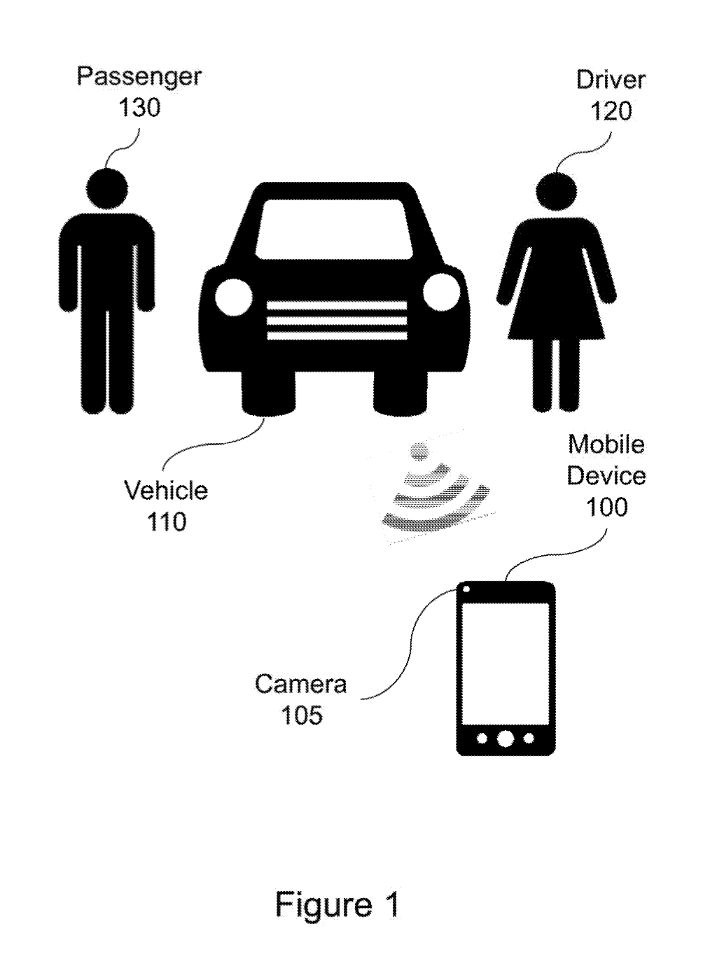

FIG. 1 illustrates an example mobile device associated with driver device locking. It should be appreciated that the items depicted in FIG. 1 are illustrative examples, and many different systems, devices, and so forth, may operate in accordance with various examples.

FIG. 1 illustrates an example mobile device 100. In this example, mobile device 100 is illustrated as a cellular phone, though in other examples mobile device 100 could be another type of device (e.g., a tablet, a laptop, a smartwatch). Mobile device 100 includes a camera 105. Here, camera 105 is designed to face the user as the user operates mobile device 100. Consequently, camera 105 may facilitate taking images of the user of mobile device 100 while mobile device 100 is in use.

First, mobile device 100 may detect that it has entered a vehicle 110. Vehicle 110 may be, for example, an automobile, a truck, and so forth. In one example, mobile device 100 may detect that it has entered vehicle 110 based on a signal received from vehicle 110. This may occur via, for example, a Bluetooth signal transmitted over a connection between vehicle 110 and mobile device 100. In other examples, mobile device 100 may rely on contextual state information to determine it has entered vehicle 110. As used herein, contextual state information may be external circumstances detectable by mobile device 110 that describe an external state of mobile device 110. Contextual state information may be learned over time by recording states of mobile device 100 during occurrences of specific events. In various examples, times, locations, velocities, accelerometer data, usage patterns, signals received from vehicle 110, distances and/or direction to a signal source associated with vehicle 110, and so forth may contribute to the contextual state of mobile device 100. By way of illustration, mobile device 100 may learn over time that a user frequently drives (e.g., to work) between 8:30 and 9:00 in mornings based on global positioning information, accelerometer data, and so forth that occur during that time frame. Consequently, upon detecting a similar state, mobile device 100 may determine it has entered vehicle 110.

Once mobile device 100 is aware it has entered vehicle 110. Mobile device 100 may then determine a driver 120 of the vehicle. In one example, mobile device 100 may detect that it is the driver of the vehicle based on a signal received from vehicle 110 itself. In this example, vehicle 110 may also be equipped with a camera that faces driver 120 as driver 120 is sitting in the driver seat of vehicle 110. The camera in vehicle 110 may transmit image information regarding driver 120 to mobile device 100. The image information may include, for example, images of the face of the driver, an iris scan of the driver, and so forth.

Upon receiving this information, when a user attempts to operate mobile device 100, mobile device 100 may use camera 105 to obtain similar image information to that received from vehicle 110. If the image information obtained by camera 105 and the image information received from vehicle 110 match, mobile device 100 may deactivate various functionalities, as matching image information may indicate that driver 120 is attempting to operate mobile device 100. While driving vehicle 110, if the image information obtained by camera 105 does not match image information received from vehicle 110, this may indicate that mobile device 100 is being operated by a passenger 130 of vehicle 110, and it is therefore safe for the passenger to use mobile device 100 with full capabilities (though other components of mobile device 100 may independently restrict access to some features).

In other examples, mobile device 100 may rely on contextual state information to determine whether driver 120 is operating vehicle 110. By way of illustration, mobile device 100 may rely on signals received from vehicle 110, distances and/or direction to a signal source associated with vehicle 110, and so forth to determine if its owner is likely to be operating vehicle 110. When mobile device 100 independently determines its owner is operating vehicle 110, mobile device 100 may have image information associated with its owner already stored within mobile device 100. Mobile device 100 may then compare image information obtained from camera 105 to the stored image information to determine if driver 120 and the owner of mobile device 100 are the same person, and selectively restrict access to various application functions when there is a match between image information from camera 105 and the image information stored in mobile device 100. If the image information obtained from camera 105 does not match the image information stored in device 100, a person other than driver 120 may be attempting to access mobile device 100. This may occur when, for example, driver 120 passes mobile device 100 to passenger 130. Because passenger 130 is not driving vehicle 110, there may not be concerns regarding mobile device usage by passenger 130. Consequently, mobile device 100 may allow access to full functionality of device 100 when the image information obtained by camera 105 does not match image information associated with driver 120.

In some examples, determining whether driver 120 is operating mobile device 100 may be enhanced by continuous and/or periodic rechecking of the user of mobile device 100. This may prevent passenger 130 from passing the mobile device 100 back to driver 120 while driver 120 without mobile device 100 from relocking features. Mobile device 100 may also handle device locking based on motion of vehicle 110. Motion of vehicle 110 may be determined based on, for example, accelerometer data, global positioning data, a signal received from vehicle 110, and so forth. Using vehicle motion data to determine whether features of mobile device 100 should be unlocked may allow driver to user 120 to operate mobile device 100 unhindered while vehicle 110 is not in motion, and a risk of accident is reduced.

In various examples, mobile device 100 may rely on user profiles for determining driver 120 of vehicle 110 and controlling access to features of mobile device 100. These profiles may include, for example, image information associated with driver 120, information describing allowable applications during operation of vehicle 110 by driver 120, and so forth. In one example, mobile device 100 may facilitate registering the user profiles. In these examples, mobile device may ask driver 120 to perform a variety of functions including taking a series of pictures to facilitate accurate driver determinations by device 100. In examples where profiles are obtained as a result of vehicle 120 including a camera and transmitting a signal to device 100 based on images obtained by that camera, device 100 may obtain the profiles from, for example, vehicle 120 itself, a cloud service, and so forth. Receiving the user profiles from the external source may facilitate transmitting the user profile to multiple mobile devices in vehicle 110, allowing mobile devices being operated by passenger 130 to be sure they are not being operated by driver 120.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, firmware, software stored on a computer-readable medium or in execution on a machine, and/or combinations of each to perform a function(s) or an action(s), and/or to cause a function or action from another module, method, and/or system. A module may include a software controlled microprocessor, a discrete module, an analog circuit, a digital circuit, a programmed module device, a memory device containing instructions, and so on. Modules may include gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

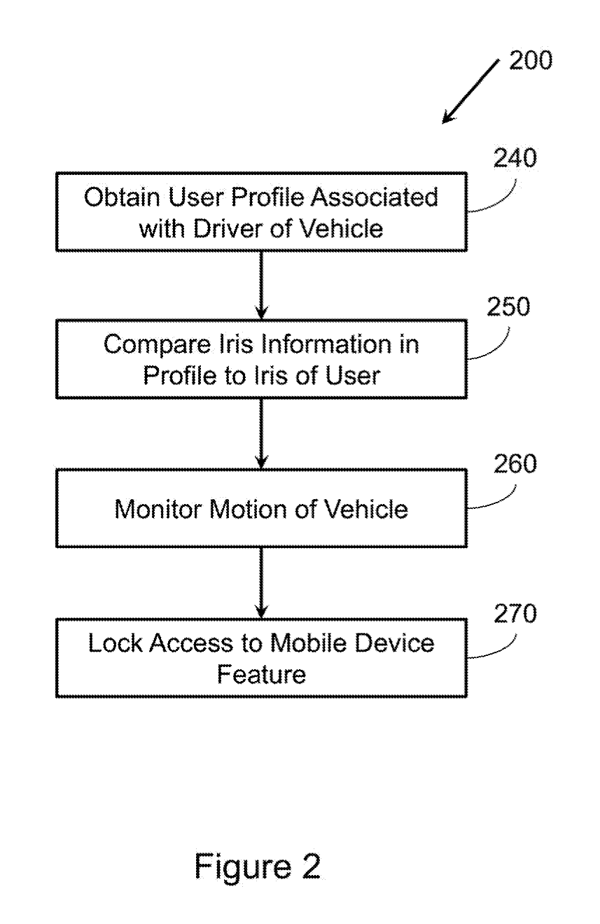

FIG. 2 illustrates an example method 200 associated with driver device locking. Method 200 may be embodied on a non-transitory processor-readable medium storing processor-executable instructions. The instructions, when executed by a processor, may cause the processor to perform method 200. In other examples, method 200 may exist within logic gates and/or RAM of an application specific integrated circuit (ASIC).

Method 200 includes obtaining a profile associated with a driver of a vehicle at 240. The profile may be obtained by a mobile device. The user profile may contain iris information associated with the driver of the vehicle. The user profile may also include, for example, facial information, other biometric information, information describing what features of the mobile device should and/or should not be accessible by the user during vehicle operation, and so forth. In one example, the user profile may be obtained from a cloud database of users. In other examples, the user profile may be obtained from a memory within the mobile device, a memory within the vehicle, and so forth. In various examples, the user profile may be obtained based on a signal received from the vehicle after the vehicle scans an iris of the driver. By way of illustration, after scanning the iris of the driver, the vehicle may transmit the user profile including the iris information to the mobile device, which the mobile device may use when examining who is operating the mobile device. In other examples, the user profile may be obtained, based on the signal, from a remote server via a network connection, from a data store on the mobile device, and so forth.

Method 200 also includes comparing iris information of a user of the mobile device to iris information associated with the driver at 250. Method 200 also includes monitoring motion of the vehicle at 260. The motion of the vehicle may be monitored based on, for example, a signal received from the vehicle, global positioning information, accelerometer information, and so forth.

Method 200 also includes locking access to a feature of the mobile device at 270. The mobile device feature may be locked when the iris information of the user matches the iris information associated with the driver and the vehicle is in motion. The feature may be, for example, a messaging feature, a web browsing feature, an application, and so forth. While all device functionalities may be disabled, it may be desirable for some functions to remain active. For example, it may be desirable for the driver of the vehicle to be able to use an application(s) that provides directions, traffic information, map information, weather information, and so forth.

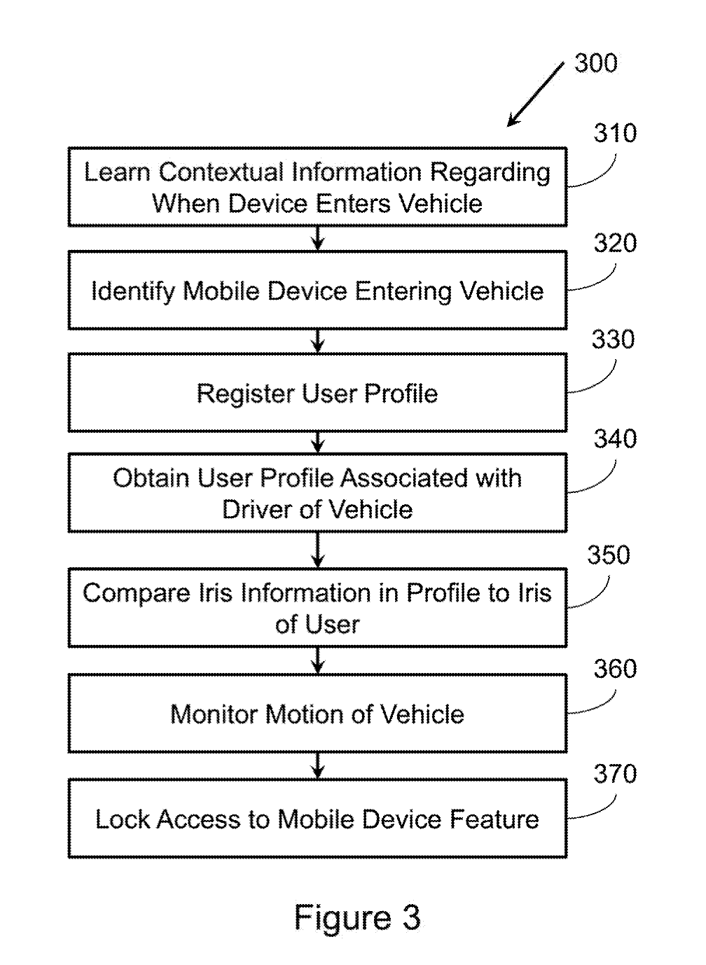

FIG. 3 illustrates a method 300 associated with driver device locking. Method 300 includes several actions similar to those described above with reference to method 200 (FIG. 2). For example, method 300 includes obtaining a user profile associated with a driver of a vehicle at 340, comparing iris information in the user profile to iris information of a user of the device at 350, monitoring motion of the vehicle at 360, and locking access to a mobile device feature at 370.

Method 300 also includes identifying when the mobile device has entered the vehicle at 320. Whether the mobile device has entered the vehicle may be identified based on contextual state information. Consequently, the user profile may be obtained based on the contextual state information. Contextual state information may include, for example, temporal information, location information, presences of nearby devices, proximity of the mobile device to a signal received from the vehicle, direction of the mobile device to a signal received form the vehicle, accelerometer data, and so forth. Temporal information y describe times when the mobile device has previously detected that the driver has operated the vehicle or another vehicle. Location information may include, for example, global positioning information that indicates a geographic location of the mobile device and whether that device is, for example, inside a building, in a parking lot, on a road, and so forth. Presences of nearby devices may indicate whether the mobile device is stationary inside a building. In another example, detection of a device associated with the vehicle may indicate that the device has entered the vehicle.

Method 300 also includes learning contextual state information to identify when the mobile device has entered the vehicle at 310. As described above, contextual state information may be information that describes an external state of the device that, in aggregate, can be used to determine whether taking certain actions (e.g., locking access to certain applications) are appropriate. Consequently, learning contextual state information may include recording external states of the device during various events to better predict when similar events occur in the future.

Method 300 also includes registering the user profile at 330. Registering the user profile may include, for example, asking the user to perform a variety of actions to facilitate better prediction of then that user is attempting to operate the mobile device. These actions may include, for example, obtaining personal information from the user, having the user take a variety of pictures that will be used when detecting who is driving the vehicle, and so forth.

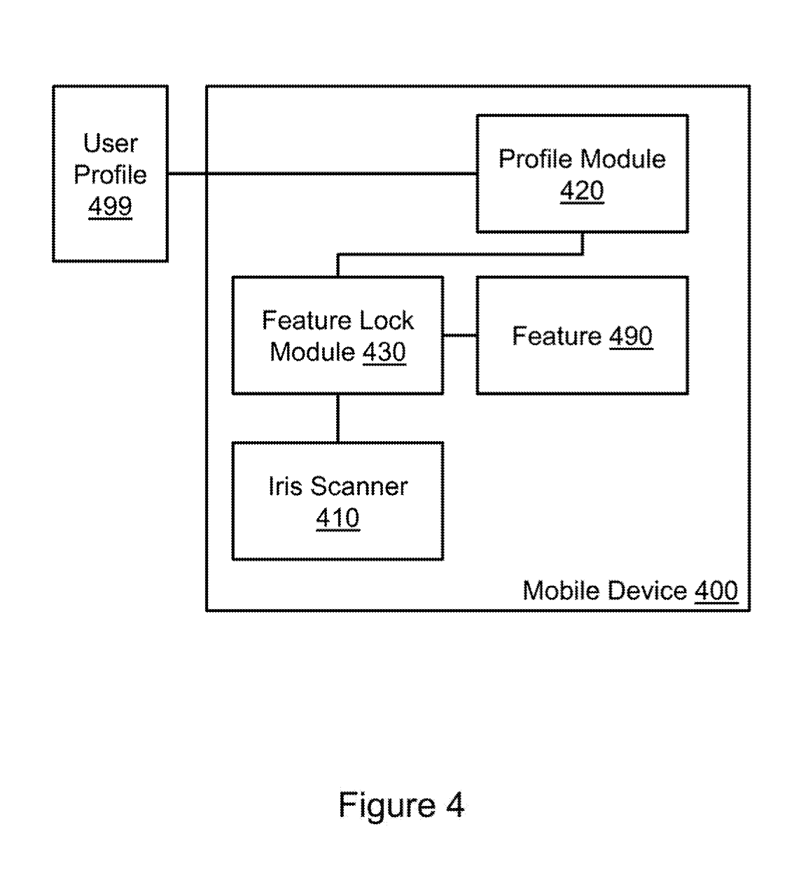

FIG. 4 illustrates a mobile device 400. Mobile device 400 includes an iris scanner 410. Iris scanner 410 may periodically obtain an iris scan of a user of mobile device 400. These periodic iris scans may facilitate determining a user of mobile device 400.

Mobile device 400 also includes a profile module 420. Profile module 420 may obtain a user profile 499 of a driver of a vehicle. Profile module 420 may obtain user profile 499 upon determining that mobile device 400 has entered the vehicle. Profile module may obtain user profile from, for example, the vehicle, a cloud storage, a memory on mobile device 400, and so forth. Profile module 420 may rely on contextual state information obtained by mobile device 400 to determine when mobile device 400 has entered the vehicle. As described above, contextual state information may include, for example, temporal information, location information, presences of nearby devices, proximity of the mobile device to a signal received from the vehicle, direction of the mobile device to a signal received form the vehicle, accelerometer data, and so forth. User profile 499 may include iris information associated with the driver of the vehicle. In other examples, mobile device 400 may receive a signal from the vehicle to determine when mobile device 400 has entered the vehicle.

Mobile device 400 also includes a feature lock module 430. Feature lock module may control mobile device 400 to enter a state that disables a feature 490 of mobile device 400. The state may be entered when the vehicle is in motion and the iris scan of the user matches the iris information in user profile 499 of the driver.

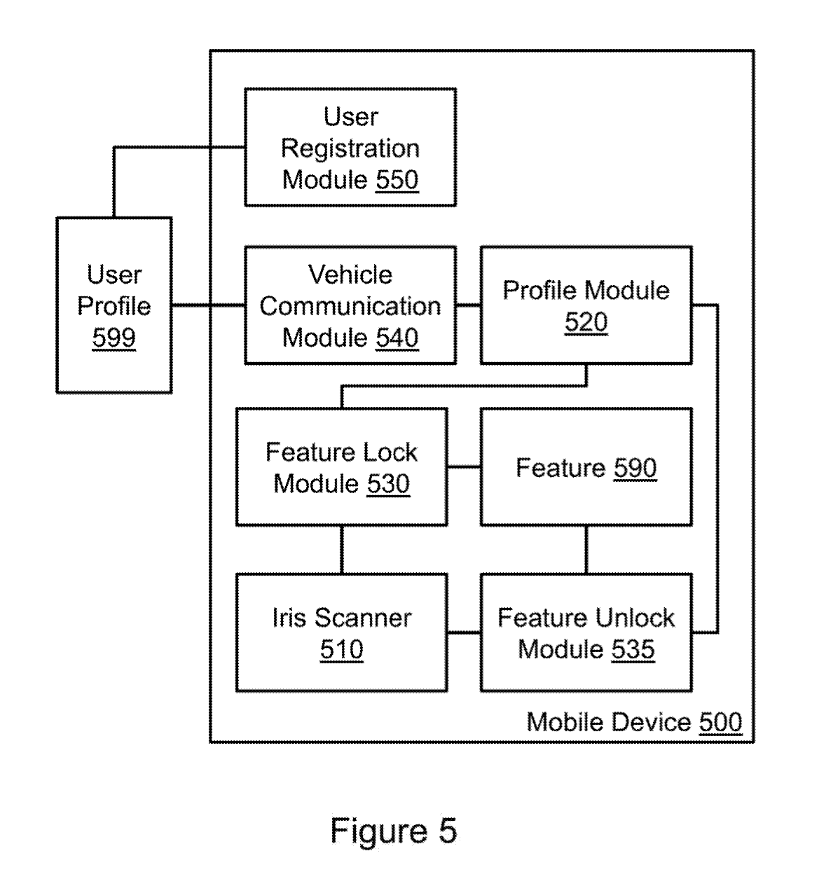

FIG. 5 illustrates a mobile device 500 associated with driver device locking. Mobile device 500 includes several items similar to those described above with reference to mobile device 400 (FIG. 4). For example, mobile device 500 includes an iris scanner 510, a profile module 520 to obtain a user profile 599, and a feature lock module 530 to disable a feature 590 of mobile device 500.

Mobile device also includes a vehicle communication module 540. Vehicle communication module 540 may receive user profile 599 of the driver. Vehicle communication module 540 may receive user profile 599 of the driver based on an iris scan of the driver of the vehicle.

Mobile device 500 also includes a user registration module 550. User registration module 550 may obtain an iris scan of the driver of the vehicle. In this example, user registration module 550 may generate user profile 599 of the driver. User registration module 550 may store user profile 599 of the driver in, for example, a memory on mobile device 500 (not shown), on a remote server, and so forth.

Mobile device 500 also includes a feature unlock module 535. Feature unlock module 535 may control mobile device 500 to enter a state that enables feature 590. Feature unlock module 535 may control mobile device 500 to enter this state, when the iris scan of the user does not match the iris information in the profile of the driver. In various examples, feature lock module 530 and feature unlock module 535 may use iris scanner 510 to continuously determine whether the iris scan of the user matches the information in the profile of the driver.

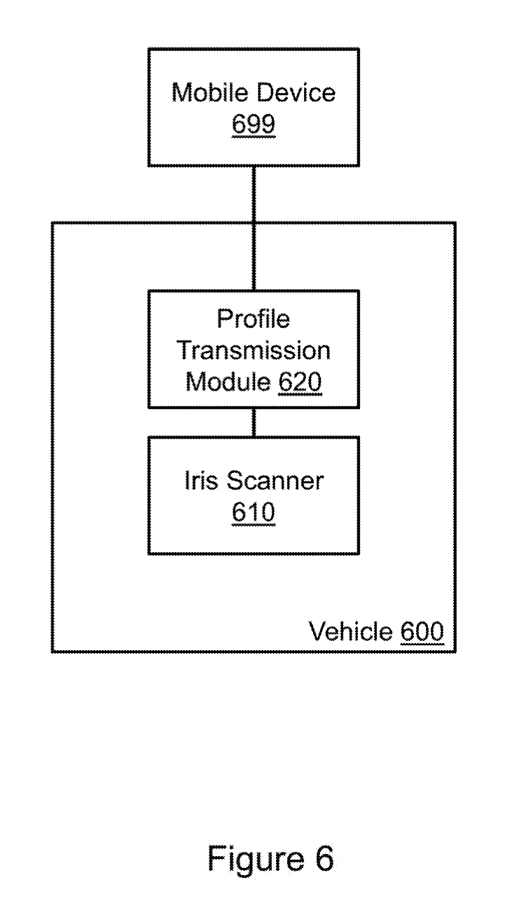

FIG. 6 illustrates a vehicle 600. Vehicle 600 may be, for example, an automobile, a truck, a boat, a plane, a motorcycle, and so forth. Vehicle 600 includes an iris scanner 610. Iris scanner 600 may periodically obtain an iris scan of a driver of vehicle 600.

Vehicle 600 also includes a profile transmission module 620. Profile transmission module may control transmission of a profile of the driver of vehicle 600 to a mobile device 699 within vehicle 600. The profile may include iris information associated with the driver of vehicle 600.

In various examples, the profile may control mobile device 699 to enter a state that disables a feature of mobile device 699 when vehicle 600 is in motion and an iris scan of the user obtained by mobile device 699 matches the iris information in the profile. This may prevent the driver of vehicle 600 from operating these features of mobile device 699 while driving vehicle 600.

In some examples, vehicle 600 may include a motion transmission module (not shown). The motion transmission module may control transmission of motion information of the vehicle to mobile device 699.

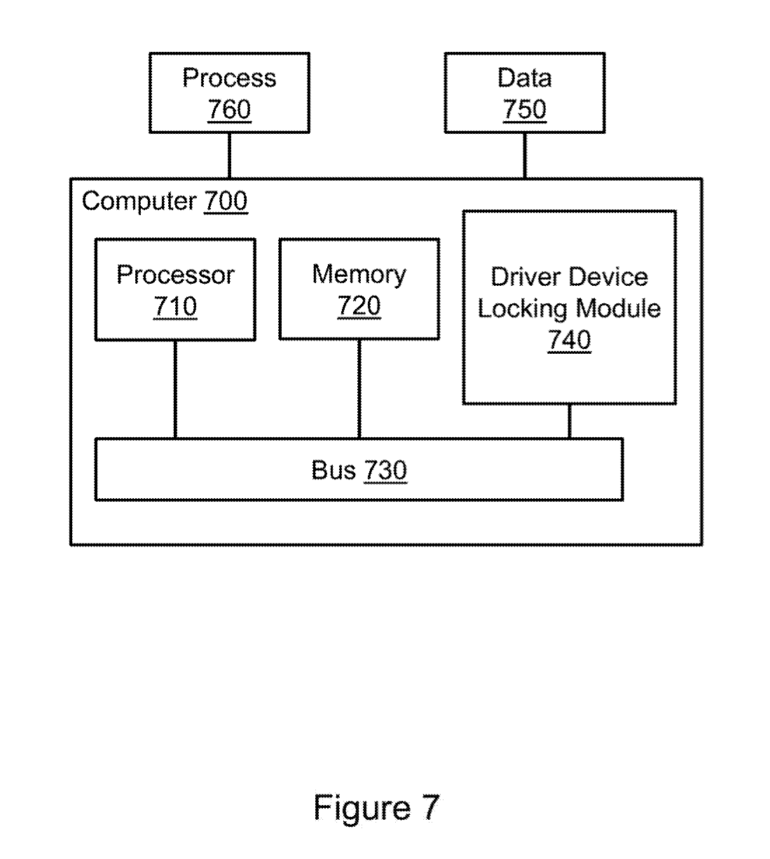

FIG. 7 illustrates an example computing device in which example systems and methods, and equivalents, may operate. The example computing device may be a computer 700 that includes a processor 710 and a memory 720 connected by a bus 730. Computer 700 includes a driver device locking module 740. Driver device locking module 740 may perform, alone or in combination, various functions described above with reference to the example systems, methods, and so forth. In different examples, driver device locking module 740 may be implemented as a non-transitory computer-readable medium storing processor-executable instructions, in hardware, software, firmware, an application specific integrated circuit, and/or combinations thereof.

The instructions may also be presented to computer 700 as data 750 and/or process 760 that are temporarily stored in memory 720 and then executed by processor 710. The processor 710 may be a variety of processors including dual microprocessor and other multi-processor architectures. Memory 720 may include non-volatile memory (e.g., read only memory) and/or volatile memory (e.g., random access memory). Memory 720 may also be, for example, a magnetic disk drive, a solid state disk drive, a floppy disk drive, a tape drive, a flash memory card, an optical disk, and so on. Thus, memory 720 may store process 760 and/or data 750. Computer 700 may also be associated with other devices including other computers, devices, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method, comprising:
obtaining, in a mobile device, a user profile associated with a driver of a vehicle, where the user profile contains iris information associated with the driver;
comparing iris information of a user of the mobile device to the to the iris information associated with the driver;
monitoring motion of the vehicle; and
locking access to a feature of the mobile device when the iris information of the user matches the iris information associated with the driver and the vehicle is in motion.

2. The method claim 1, where the user profile is obtaining from a cloud database of users.

3. The method of claim 1, where the user profile is obtained based on a signal received from the vehicle after the vehicle scans an iris of the driver.

4. The method of claim 1, comprising
identifying, based on contextual state information, that the mobile device has entered the vehicle; and where the user profile is obtained based on the contextual state information.

5. The method of claim 4, comprising learning contextual state information to identify when the mobile device has entered the vehicle.

6. The method of claim 4, where the contextual state information includes at least one of, temporal information, location information, presences of nearby devices, proximity of the mobile device to a signal received from the vehicle, direction of the mobile device to a signal received from the vehicle, and accelerometer data.

7. The method of claim 1, comprising registering the user profile.

8. The method of claim 1, where the feature is one of a messaging feature, a web browsing feature, and an application.

9. A mobile device, comprising:
an iris scanner to periodically obtain an iris scan of a user of the mobile device;
a profile module to obtain a profile of a driver of a vehicle upon determining that the mobile device has entered the vehicle based on contextual state information obtained by the mobile device, where the profile of the driver includes iris information associated with the driver;
a feature lock module to control the mobile device to enter a state that disables a feature of the mobile device when the vehicle is in motion and the iris scan of the user matches the iris information in the profile of the driver.

10. The mobile device of claim 9, comprising a user registration module to obtain an iris scan of the driver of the vehicle and to generate the profile of the driver.

11. The mobile device of claim 9, comprising a vehicle communication module to receive, based on an iris scan of the driver of the vehicle, a profile of the driver of the vehicle.

12. The mobile device of claim 9, comprising a feature unlock module to control the mobile device to enter a state that enables the feature of the mobile device when the iris scan of the user does not match the iris information in the profile of the driver.

13. The mobile device of claim 12 where the feature lock module and the feature unlock module use the iris scanner to continuously determine whether the iris scan of the user matches the information in the profile of the driver.

14. A vehicle, comprising:
an iris scanner to periodically obtain an iris scan of a driver of the vehicle; and
a profile transmission module to control transmission of a profile of the driver of the vehicle to a mobile device within the vehicle, the profile including iris information associated with the driver of the vehicle,
where the profile controls the mobile device to enter a state that disables a feature of the mobile device when the vehicle is in motion and an iris scan of the user obtained by the mobile device matches the iris information in the profile.

15. The vehicle of claim 15, comprising a motion transmission module to control transmission of motion information of the vehicle to the mobile device.
